(19) United States
(12) Patent Application Publication
(10) Pub. No.: US 2008/0230428 A1
(43) Pub. Date: Sep. 25, 2008

(54) Tactile Film and Applications Therefor

(75) Inventor: Shalendra Singh, Cumbria (GB)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: INNOVIA FILMS LIMITED, Wigton, Cumbria (GB)

(21) Appl. No.: 11/995,854

(22) PCT Filed: Jul. 19, 2006
(86) PCT No.: PCT/GB2006/050216

§ 371 Date: Feb. 26, 2008

(30) Foreign Application Priority Data
Jul. 19, 2005 (GB) 0514785.5

(51) Int. Cl. B32B 27/32; B65D 65/40; B65D 75/26

(52) U.S. Cl. 206/524.2; 428/523; 428/515; 428/336; 428/409; 383/109; 229/87.01

(57) ABSTRACT

The invention concerns a coated biaxially oriented polypropylene film which comprises a core layer consisting of a homo-polymer of polypropylene with skin layers formed from a block copolymer of polyethylene and polypropylene, the skin layers having been treated with a primer with a heat sealable coating on each skin layer, and each coated side being readily printable with solvent and water based inks and resistant to thermal and humidity blocking, the thickness of the skin layers being selected so as to fall in the range 2.8 to 4.5 microns having a wide angle haze factor of at least 3 and not exceeding 50, coupled with a gloss (45 degrees) factor of at least 20% and not exceeding 100%.

This invention relates to a tactile film and to applications therefore especially in packaging applications, for example in sealed ream wrap packaging applications, and to films suitable for forming sealed ream wrap packages.

Polymeric films have a wide variety of applications, for example in the packaging industry and also in overwrap and labeling technologies. In many such applications it can be desirable for the film to have good tactility—to be pleasant to the touch. In particular it may be desirable for the surface of the film to be slightly yielding to the touch or to have a slight resilience or elasticity when touched.

One application of polymeric films in the packaging industry is in sealed ream wrap packages, or ream wrappers. Reams of cut paper for copy machines, computers, printers, and other applications are most commonly packaged for shipping, storage, and retail sale in ream wrappers made of various wrap materials. These wrap materials traditionally have been paper, plastic film, or a paper/plastic film laminate. The wrap materials protect the wrapped paper product from physical damage and moisture pickup during shipping and storage. The wrap materials also protect the wrapped product from physical damage during repeated handling and stocking on retail shelves.

The distribution of reams of paper has changed from boxes for large users to wrapped reams for sale in individual packages containing e.g 500 sheets. Such distribution of reams of paper has placed increasing demands on the wrapper due to more frequent handling of the individual reams. Increased handling of the reams has resulted in more reams breaking open, damaging the wrapped paper product by allowing it to pick up moisture, tear, or get minor curl—physical damage that ultimately results in jams in the end-user's printer or copy machine. However the resultant ability of a package to avoid damage arising from handling means that the packaged product is more difficult to open.

One way of overcoming this problem would be to provide sealing means that possesses a mechanical resistance sufficient to maintain the seal intact during storage and transport until such time as the packaging or wrapping is to be opened but the package remains capable of being opened manually at or near the seal without risk of damaging the wrapped paper product.

In stretched polyolefin films, in particular biaxially oriented polypropylene films, the mechanical strength of seal seams is often higher than that of the film itself, and therefore when a sealed pack is opened it is not only the seal seam which is broken apart. Typically, a tear propagates in an uncontrolled manner through the entire film upon opening. Peelable films are films which once sealed can be separated again mechanically without damaging or destroying the film itself. Peelable seal layers are typically required to have good sealing properties and also permit controlled opening of a bag or package.

A peelable heat sealable film can be formed when a coated film is formed by coating a biaxially oriented polypropylene film formed as multilayer film with a core of a homo-polymer of polypropylene with a skin layer formed on each side or major surface of the core with a heat sealable coating. Such skin layers may be formed from copolymers such as copolymers of propylene and ethylene including block copolymer. The skin layer formed as a melt coat during the production of the film it is believed gives a peeling seal when coated by virtue of incompatible phases in the melt coat. This limits the plane of failure to the melt coat itself, away from the core layer avoiding any possibility of a tearing seal in the core. The result is a seal that is weaker than a conventional seal but gives the same seal strength throughout the pull and doesn't tear.

EP 746468 describes a multilayer film which peels by rupture within what is referred to in the specification as an intermediate layer between a base layer and a heat sealable layer. The intermediate layer is formed from a blend of a propylene polymer and an ethylene polymers it is suggested that the thickness of these layers can be between 2 and 9 microns preferably 3 and 7 microns, though the smallest thickness exemplified is 5 microns. The specification includes the following:

“The intermediate layer is preferably a blend of polymers such that the blend does not co-crystallise and that no interface is created within the interlayer. Such non-co-continuous structures are believed to fail by a mechanism whereby failure propagates through domain boundaries between the components of the blend, and this occurs preferentially by ductile failure. Thus the intermediate layer will often result in films of the present invention having increased haze compared with analogous films without the intermediate layer. Where substantially transparent films are required it is preferred that this increase in haze is not so great that the intermediate layer becomes essentially non-transparent, but a non-transparent intermediate layer can be used when the films themselves are to be opaque.”

U.S. Pat. No. 6,231,975 describes a sealable film comprising: (a) an inner layer comprising an olefin polymer; (b) a sealing layer; and (c) a separable layer positioned between the inner layer and sealing layer, the separable layer comprising an ethylene-propylene copolymer or a blend of polyethylene and another olefin which forms an incompatible mixture or blend. The sealed film can be unsealed by causing the sealing layer to separate from the inner layer without substantially impacting the integrity of either the sealing layer or the inner layer and that: a coating can be applied to the seal layer which facilitates sealing of the film to itself or to another film surface, Examples of suitable coatings include acrylic, polyvinylidene chloride, or ethylene-acrylic acid copolymer, among others and further that: the thickness of the separable layer can be important. In general, depending upon the material of the separable layer, the separable layer can constitute at least about 20%, preferably about 30% to about 50% of the entire thickness of the film. For example, in a film of about 10 .mu.m to about 80 .mu.m, specifically about 15 mu.m to about 35 .mu.m, and when the separable layer is, for example, ethylene block copolymer or a blend of ethylene polymer and polypropylene, the separable layer should range from about 5 .mu.m to about 15 .mu.m, specifically about 7 .mu.m to about 12 .mu.m.

U.S. Pat. No. 4,565,738 describes a multiple-layer film comprising a polyolefin base layer and, on at least one surface thereof, a receptive layer wherein the polyolefin of the base layer comprises a propylene polymer and the at least one receptive layer comprises a blend of (a) a propylene-ethylene end block copolymer containing from 1 to 20% of ethylene by weight of the end block copolymer, and (b) an ethylene-mono-alpha olefin random copolymer containing from 1 to 15% by weight of the random copolymer of a mono-alpha olefin the molecule of which contains from 3 to 10 carbon atoms, the weight ratio of the propylene-ethylene end block copolymer to the ethylene-mono alpha olefin random copolymer in the blend being within a range of from 0.5:1 to 99:1. This film is suitable for incorporation into heat-sealable films which yield peelable seals. Such a peelable seal is disclosed in U.S. Pat. No. 4,565,738 with a skin layer thickness in the range 0.2 to 1.0 μm.

Attempts by the applicants to use such a known peelable film in the packaging of reams of paper in the equipment used for this purpose failed. It is believed that this is because the equipment forms the package with a so-called envelope seal. In forming such a seal, pressure is not applied uniformly along the area being sealed, and this it is believed may physically distort the uniformity of the laminar structure of the film. Such distortion may then produce an area within the skin layer where the tear will follow a propagation path into the core rather than continue to peel along the skin layer.

We have now found that by selecting an increased thickness of skin layer and choosing a block co-polymer, preferably of polyethylene and polypropylene, for the material from which the skin layer is formed we can form a tactile film which can be used in a wide variety of packaging, labeling and overwrap applications, which is somewhat yielding resilient or elastic to the touch and which therefore has a “soft-feel” characteristic, and which when used to wrap articles such as reams of paper with an envelope seal not only forms a package with peelable seal but also provides a distinctive appearance to the package so formed. We have found that this change in appearance can be defined to some extent by the haze and gloss factors of the film.

According to the invention there is provided a tactile multi-layer film comprising at least a polyolefinic core and a block copolymeric skin layer.

The polyolefinic core may itself comprise a homopolymer, for example a polypropylene homopolymer, in particular an oriented polypropylene homopolymer.

The block copolymeric skin layer preferably comprises a polyolefinic copolymer, for example a block copolymer of two different polyolefins, in particular a block copolymer of polyethylene and polypropylene. It may comprise one or more heterophasic polymers, for example heterophasic polyolefinic polymers.

The skin layer may be present on one or both sides of the core. The core may itself have a multilayer structure. The skin layer(s) may be coextruded onto the core.

The or each skin layer preferably has a thickness of from about 2.8 μm to about 4.5 μm.

The or each skin layer may be provided with a coating to aid sealability and/or printability of the film. The or each skin layer may be treated with a primer to facilitate reception of such a coating. The or each coating may for example be a heat sealable coating and/or a coating printable with solvent and/or water based inks. The or each such coating applied to the film may be based on acrylic polymers.

According to the invention there is provided a coated biaxially oriented polypropylene film which comprise a core layer consisting of a homo-polymer of polypropylene with skin layers formed from a block copolymer of polyethylene and polypropylene, the skin layers having been treated with a primer with a heat sealable coating on each skin layer, and each coated side being readily printable with solvent and water based inks and resistant to thermal and humidity blocking, the thickness of the skin layers being selected so as to fall in the range 2.8 to 4.5 microns.

The invention also concerns a sealed ream wrap package formed from such a film.

Also provided in accordance with the invention is a polyolefinc film in accordance with the foregoing description having a wide angle haze factor of at least 3 and not exceeding 50, coupled with a gloss (45°) factor of at least 20% and not exceeding 100%.

The invention also includes a sealed ream wrap package with a distinctive appearance that is achieved due to the film used to wrap the paper film having the aforesaid appearance properties.

Thus, in one of its aspects the invention provides a coated biaxially oriented polypropylene film which comprises a core layer consisting of a homo-polymer of polypropylene with skin layers formed from a block copolymer of polyethylene and polypropylene, the skin layers having been treated with a primer with a heat sealable coating on each skin layer, and each coated side being readily printable with solvent and water based inks and resistant to thermal and humidity blocking, the thickness of the skin layers being selected so as to fall in the range 2.8 to 4.5 microns having a wide angle haze factor of at least 3 and not exceeding 50, coupled with a gloss (45 degrees) factor of at least 20% and not exceeding 100%.

Wide angle haze (WAH) of a sample of film is the percentage of transmitted light which in passing through the sample, deviates from the incident beam by more than 2.5 degrees forward scattering. The measurements of WAH of films made in accordance with the invention disclosed herein were made using an E.E.L Spherical Haze Meter. The test method is described in ASTM D1003 test method.

Surface or specular gloss is the ratio of the luminous flux reflected from, to that incident on, the sample being measured for specified solid angles at the specular direction i.e. the angles of incidence and reflection are equal. The angle used is 45°. The test method is described in ASTM D2457. The measurement of surface gloss of films made in accordance with the invention disclosed herein was made using a Novo gloss glossmeter with a rho point of 45°.

The use of particular thicknesses of skin layer sealable has unexpectedly made it possible to produce a film not only with a distinctive appearance but also distinctive feel. This latter characteristic is not is not easily defined in a quantitative manner but qualitatively, this characteristic enables the films of the present invention to be easily distinguished from prior art films by the softness or resilience of the films, and of packages, labels and overwrap made therefrom.

The skin layer may be applied to the base film by a coextrusion technique in which the polymeric components of the base and blend layers are coextruded into intimate contact while each is still molten. Preferably, the coextrusion is effected from a multi-channel annular die so designed that the molten polymeric components constituting individual layers of the composite film merge at their boundaries within the die to form a single composite structure which is then extruded from a common die orifice in the form of a tubular extrudate. The dimensions of the die and the ratio of the co-extruder polymer output in relation to the core polymer extrusion output are used to determine the thickness of the skin layers.

Conveniently, the polyolefin base material and the copolymer blend layer are coextruded in the form of a composite tube which is subsequently quenched, reheated, and then expanded by internal gas pressure to induce transverse orientation, and withdrawn, at a rate greater than that at which it is extruded, to stretch and orient it in the longitudinal direction.

The degree to which the film is stretched depends to some extent on the ultimate use for which the film is intended, but for a polypropylene-based packaging film we find that satisfactory tensile and other properties are developed when the machine direction and transverse direction stretch ratios are preferably in the range from 4:1 to 10:1 preferably from 6:1 to 8:1.

The distinctive feel of the films of the invention is apparent when a package, for example a ream wrap package made with such a film, is lifted when the softness/resilience of the packaging distinguishes it from a conventional ream wrapped package.

The sale of ream wrapped paper both for use in copying machines and computer printers is a commodity market where the consumer is faced with a choice between various brands and qualities of paper. It is desirable to provide a package which is not only easy to open without damage to the contents but can be distinguished by other physical properties. Thus the ream wrapped packages of the present invention can be advertised as being capable of being opened with a reduced risk of damage to the contents, and also as being easily recognized by the distinctive appearance of the package. The consumer can be helped in selecting a package with a peelable seal by the actual feel of the package when lifted from a shelf in a retail store. A high proportion of ream wrap paper is selected by the consumer from the shelves in a retail store.

The packages of the invention because their distinctive appearance and if it is wished enable the use of print to achieve distinctiveness to be limited. This is desirable because the print layers on packages while providing distinctiveness also make the packages more difficult to handle on a production line because of the reduction in the coefficient of friction, The packages of the present invention can therefore be distinctive in appearance without large areas of printing.

The film of the invention may also me used in connection with the so-called naked collation of packaged articles, such as cigarette packs for example. According to the invention there is provided a package comprising a plurality of similar articles of commerce wrapped in the film of the invention by means of naked collation.

The following example illustrates but does not limit the invention.

### EXAMPLE

This example shows the change in haze and gloss factor as the skin layer thickness is increased from 0.6 to 4.5 microns. In all cases a biaxially oriented polypropylene film coated with an acrylic coating of the composition set out below at a coating weight of 1 gsm was used and the skin layers were formed from an ethylene propylene block copolymer. The films where the skin layers were 4.5 and 2.8 microns all formed peelable seals when the film was used to form a ream wrap package.

Measurements are also given for the uncoated base film.

### Wide Angle Haze (WAH)

| | Layer | | |
|---|---|---|---|
| | thickness | Base | acrylic coated |
| 1 | 4.5 microns | 94.0-95.0 | 42.3-45.3 |
| 2 | 2.8 microns | 78.5-83.4 | 34.9-38.8 |
| 3 | 0.6 microns | 3.6-5.6 | 1.3-2.4 |

### Gloss Measurement. (Gloss %)

| | | | | acrylic | |
|---|---|---|---|---|---|
| | layer | base | | coated | |
| | thickness | side one | side two | side one | side two |
| 1 | 4.5 microns | 6.3-6.5 | 10.1-15.5 | 22.6-24.6 | 42.0-45.6 |
| 2 | 2.8 microns | 11.3-13.5 | 16.8-18.3 | 28.4-30.7 | 54.5-57.5 |
| 3 | 0.6 microns | 99.5-101.5 | 99.5-104.8 | 94.8-97.0 | 94.4-97.5 |

The acrylic coating was formulated as a production batch using as a source of the acrylic material present in the coating WB1240. WB1240 is an acrylic copolymer dispersion in water supplied by UCB Surface Specialities of Rue d'Anderlect 33 B-1620 Drogenbos Belgium and the quantity used was that necessary to give a coating composition on the films in which the WB 1240 formed 92.5 weight percent of the entire coating. The composition also contained 0.25 weight percent of polymethylmethacrylate particles as an antiblock and 7.5 weight percent of Carnauba wax.

1. A tactile multi-layer film comprising at least a polyolefinic core and a block copolymeric skin layer.

2. The film according to claim 1, wherein the polyolefinic core comprises a homopolymer.

3. The film according to claim 2, wherein the homopolymer comprises a polypropylene homopolymer.

4. The film according to claim 3, wherein the polypropylene homopolymer comprises an oriented polypropylene homopolymer.

5. The film according to claim 1, wherein the block copolymeric skin layer comprises a polyolefinic copolymer.

6. The film according to claim 5, wherein the polyolefinic copolymer comprises a block copolymer of two different polyolefins.

7. The film according to claim 6, wherein the polyolefinic copolymer comprises a block copolymer of polyethylene and polypropylene.

8. The film according to claim 1, wherein the skin layer is provided on both sides of the core.

9. The film according to claim 1, wherein the core has a multilayer structure.

10. The film according to claim 1, wherein the or each skin layer is coextruded onto the core.

11. The film according to claim 1, wherein the or each skin layer has a thickness of from 2.8 μm to 4.5 μm.

12. The film according to claim 11, wherein the or each skin layer has a thickness of from 2.9 μm to 4.4 μm.

13. The film according to claim 1, wherein the or each skin layer is provided with a coating to aid sealability and/or printability of the film.

14. The film according to claim 13, wherein the or each skin layer is treated with a primer to facilitate reception of the coating.

15. The film according to claim 13, wherein the or each coating comprises a heat sealable coating and/or a coating printable with solvent and/or water based inks.

16. The film according to claim 13, wherein the or each coating applied to the film is based on acrylic polymers.

17. The film according to claim 1 comprising a coated biaxially oriented polypropylene film which comprise a core layer consisting of a homopolymer of polypropylene with skin layers formed from a block copolymer of polyethylene and polypropylene, the skin layers having been treated with a primer with a heat sealable coating on each skin layer, and each coated side being readily printable with solvent and water based inks and resistant to thermal and humidity blocking, the thickness of the skin layers being selected so as to fall in the range 2.8 to 4.5 microns.

18. The film according to any claim 1 having a wide angle haze factor of at least 3 and not exceeding 50.

19. The film according to claim 18 having a wide angle haze factor of at least 5 and not exceeding 45.

20. The film according to claim 19 having a wide angle haze factor of at least 10 and not exceeding 40.

21. The film according to claim 1 having a gloss (45°) factor of at least 20% and not exceeding 100%.

22. The film according to claim 21 having a gloss (45°) factor of at least 25% and not exceeding 90%.

23. The film according to claim 22 having a gloss (45°) factor of at least 30% and not exceeding 80%.

24. The film according to claim 1 being a coated biaxially oriented polypropylene film which comprises a core layer consisting of a homopolymer of polypropylene with skin layers formed from a block copolymer of polyethylene and polypropylene, the skin layers having been treated with a primer with a heat sealable coating on each skin layer, and each coated side being readily printable with solvent and water based inks and resistant to thermal and humidity blocking, the thickness of the skin layers being selected so as to fall in the range 2.8 to 4.5 microns having a wide angle haze factor of at least 3 and not exceeding 50, coupled with a gloss (45 degrees) factor of at least 20% and not exceeding 100%.

25. A package, overwrap or label made from a film according to claim 1.

26. A ream wrap package according to claim 25.

27. A package comprising a plurality of similar articles of commerce wrapped in the film according to claim 1 by means of naked collation.

28. The film according to claim 14, wherein the or each coating comprises a heat sealable coating and/or a coating printable with solvent and/or water based inks.

29. A package, overwrap or label made from a film according to claim 2.

30. A package, overwrap or label made from a film according to claim 17.

31. A package, overwrap or label made from a film according to claim 24.

32. A package comprising a plurality of similar articles of commerce wrapped in the film according to claim 2 by means of naked collation.

33. A package comprising a plurality of similar articles of commerce wrapped in the film according to claim 17 by means of naked collation.

34. A package comprising a plurality of similar articles of commerce wrapped in the film according to claim 24 by means of naked collation.
